(19) United States
(12) Patent Application Publication
(10) Pub. No.: US 2025/0380711 A1
(43) Pub. Date: Dec. 18, 2025

(54) PROTEIN FORMING MACHINE

(71) Applicants: Tracy Brian Hare, Lagrange, GA (US); Kenneth J. Wetenkamp, Plymouth, WI (US); Michael Haines, Sheboygan Falls, WI (US)

(72) Inventors: Tracy Brian Hare, Lagrange, GA (US); Kenneth J. Wetenkamp, Plymouth, WI (US); Michael Haines, Sheboygan Falls, WI (US)

(21) Appl. No.: 19/035,588

(22) Filed: Jan. 23, 2025

Related U.S. Application Data
(60) Provisional application No. 63/625,323, filed on Jan. 26, 2024.

(51) Int. Cl. A22C 7/00

(52) U.S. Cl. CPC A22C 7/0076

(57) ABSTRACT

A servo-driven plate forming machine comprising: a mold plate that operates at (120) 10″ strokes per minute; a single hydraulic pump combined with proportional hydraulic valves with closed and open loop controls; individually controlled feed screws to control whole muscle integrity and retain particle definition; and a one piece hopper that assists in providing a substantially leak proof feed.

### CROSS-REFERENCE TO RELATED APPLICATIONS

This application claims priority to and benefit of Provisional Application Ser. No. 63/625,323 filed Jan. 26, 2024.

### FIELD OF THE INVENTION

The present invention relates to a plate forming device to form patties.

### BACKGROUND OF THE INVENTION

Before automation, consumers generally formed patties of food product by hand. However, demand (e.g., the fast-food industry) for high-speed and high-volume product of food products led to the development of automated machines configured to provide molded food product. Generally, such machines mold the food product under pressure into patties of various shapes and sizes. A typical application for food product molding machines is in the production of hamburger patties. Yet, the type of food product (e.g., vegetables, meat, fish, etc.) and shape (e.g., rods, patties, etc.) can vary. The molded food products are distributed to restaurants, grocery stores, etc. The demand for high volume, high-speed food product molding machinery continues to grow.

### SUMMARY OF THE INVENTION

The present invention relates to a servo-driven plate forming machine designed to operate at (120) 10″ strokes per minute normal operation, which is a significant increase in productivity over current market plate forming machines. The present invention utilizes a sanitary design for increased cleanliness, ease of clean-in-place procedures, and reduced food product waste through leakage control, which is a weak point in current market plate forming machines.

Efficiency improvements of the present invention are achieved by a single hydraulic pump combined with proportional hydraulic valves with closed and open loop controls, and improved ease of maintenance features. The invention improves product quality by using individually controlled feed screws to control whole muscle integrity and retain particle definition.

It is an object of the present invention for the machine to use about 70% fewer moving wear components, including components to the knock out system and drive system. This improves product delivery system.

It is an object of the present invention for the machine of the present invention to have a substantially leak proof feed. This is accomplished by a one piece hopper, wherein existing designs have a several piece hopper.

It is an object of the present invention for the machine to provide more control of whole muscle integrity by not using a feed pump to force the meat through to the plunger and pump box. Prior art machines run meat through a pump whereas the present invention traps meat between flutes of spiral screws and the sides of a cylindrical chamber, then push the meat into the plunger chamber. With the method of the present invention, the meat is kept more whole, and experiences less damage to the cellular structure.

It is an object of the present invention for the machine to have particle definition retention.

It is an object of the present invention for the machine to have improved portion weight control. With advanced hydraulic controls a user can control pressure of meat in the pump box and mold plate and get closed loop feedback of pressure. This insures that the desired amount of pressure is placed on the meat in the cavity. The system provides more consistent filling of the cavities. The hydraulics are more quickly reactive with less lag time.

It is an object of the present invention for the machine to have increased throughput of up to 33%.

It is an object of the present invention for the machine to have forming speeds of up to 120 strokes per minute.

It is an object of the present invention for the machine to comprise a servo driven mold plate and knock-out.

It is an object of the present invention for the machine to be able to use any existing 26 series forming plates.

It is an object of the present invention for the machine to use a single hydraulic pump.

It is an object of the present invention for the machine to use servo-proportional plunger hydraulics.

It is an object of the present invention for the machine to have pneumatically activated seal to stop leaks between mold cover, receiver and pump box.

It is an object of the present invention for the machine to have an O-ring located between the hopper and receiver. This assists to minimize leakage in this area.

It is an object of the present invention to have a configurable breathing slot. This is accomplished using configurable inserts. Traditional, prior art slots in the hoppers are fixed. The breather slot of the present invention is removable to change how big the slot is. It is an object of the present invention for the configurable breathing slot to control breathing in the fill system, to assist in proper filling of the mold plate cavities and reduction in product loss.

It is an object of the present invention to have a feed screw installation as part of the drive wherein the rear hopper seal plate allows movement so the feed screws can self-align when the operator closes the feed screw gear motors to engage feed screws.

It is an object of the present invention for the machine to have a trapezoidal or pyramid feed screw drive engagement.

It is an object of the present invention for the machine to have flexible hydraulic power unit connections that allow the hydraulic power unit to rotate out of the machine for services/adjustments without disconnecting hoses.

It is an object of the present invention for the machine to have a two-piece pump box. This creates a manufacturing and hygienic advantage.

It is an object of the present invention to have four programmable feed screws. With four programmable screws there is not as much blending of meat. This has an advantage over the standard two or three feed screws on prior art machines. It is an object of the present invention to have four round plungers to minimize leakage and give more uniform mold cavity filling.

The machine of the present invention is designed to produce formed poultry, beef, sausage and plant based protein.

It is an object of the present invention for the machine to have a drive train that a single main reducer, driven by a single servo motor. The main reducer has two output shafts which split the power into two 1:1 direction changing gearboxes.

It is an object of the present invention for the machine to have a rotary tube valve that has four holes instead of two, which is fed by four plungers. This assists in weight control and reduces meat flow distance through the tube valve to better fill the cavities.

It is an object of the present invention for the machine to control hydraulic fluid flow rate independently and simultaneously.

It is an object of the present invention for the machine to be able to precisely command position and pressure of the plungers via a closed loop feedback for position and pressure independently along with open loop feedback for flow rate independent of position and pressure; these features are combined in a protein forming machine.

### BRIEF DESCRIPTION OF DRAWINGS

FIG. 1a is a front view of the machine of the present invention.

FIG. 1b is a top view of the machine of the present invention.

FIG. 1c is a side view of the machine of the present invention.

FIG. 2 is a right front perspective view of the machine of the present invention.

FIG. 3a is a right front perspective view of the servo mold plate drive and knock-out of the machine of the present invention.

FIG. 3b is a top view of the servo mold plate drive and knock-out of the machine of the present invention.

FIG. 4a is a right front perspective view of the rapid clean in place preparation of the machine of the present invention.

FIG. 4b is a left rear perspective view of the rapid clean in place preparation of the machine of the present invention.

FIG. 5a shows front view of the improved maintenance access of the machine of the present invention.

FIG. 5b shows a top view of the improved maintenance access of the machine of the present invention.

FIG. 6a shows a right side view of a receiver seal, legacy hopper interface of the machine of the present invention.

FIG. 6b shows an enlarged view of FIG. 6a of the receiver seal, legacy hopper interface of the machine of the present invention.

FIG. 6c shows an enlarged view of FIG. 6a of the receiver seal, legacy hopper interface of the machine of the present invention.

FIG. 6d shows an enlarged view of FIG. 6a of the receiver seal, legacy hopper interface of the machine of the present invention.

FIG. 7a is a top view of a receiver and pump box of the machine of the present invention.

FIG. 7b is a right front perspective view of a pneumatically activated seal between mold cover, receiver and pump box of the machine of the present invention.

FIG. 7c is a front perspective view of a pneumatically activated seal between mold cover, receiver and pump box of the machine of the present invention.

FIG. 7d is a side view of a pneumatically activated seal between mold cover, receiver and pump box of the machine of the present invention.

FIG. 7e is a front view of a pneumatically activated seal between mold cover, receiver and pump box of the machine of the present invention.

FIG. 7f is a cross-sectional view through section C-C of FIG. 7d of the machine of the present invention.

FIG. 7g is a right front perspective view of the pneumatically activated seal of the machine of the present invention.

FIG. 7h is a detailed view of the pneumatically activated seal between mold cover, receiver and pump box of the machine of the present invention.

FIG. 8a shows a right front perspective view of an assembled O ring seal between a hopper and receiver of the machine of the present invention.

FIG. 8b shows a top view of an assembled O ring seal between a hopper and receiver of the machine of the present invention.

FIG. 8c is an enlarged prospective view of an O ring seal between a hopper and receiver of the machine of the present invention.

FIG. 8d is a cross sectional view of section A-A of FIG. 8b showing an O ring seal between a hopper and receiver of the machine of the present invention.

FIG. 8e is a detailed view of Section b from FIG. 8d showing an O ring seal between a hopper and receiver of the machine of the present invention.

FIG. 9a is an assembled two piece pump box with receiver of the machine of the present invention.

FIG. 9b is an unassembled two piece pump box of the machine of the present invention.

FIG. 9c is a side view of an unassembled two piece pump box of the machine of the present invention.

FIG. 10a is a right rear perspective view of an assembled two piece pump box of the machine of the present invention

FIG. 10b is a right rear perspective view of an unassembled two piece pump box of the machine of the present invention.

FIG. 10c is a right rear perspective view of the rear half of the two piece pump box of the machine of the present invention.

FIG. 10d is a right rear perspective view of the front half of the two piece pump box of the machine of the present invention.

FIG. 10e is a right front perspective view of the rear half of the two piece pump box of the machine of the present invention.

FIG. 10f is a right front perspective view of the front half of the two piece pump box of the machine of the present invention.

FIG. 11a is a top view of a configurable breather slot plate of the machine of the present invention.

FIG. 11b is a right front perspective view of a configurable breather slot plate of the machine of the present invention.

FIG. 11c is a side view of Section A-A of FIG. 11a, of a configurable breather slot plate of the machine of the present invention.

FIG. 11d is a front view of a configurable breather slot plate of the machine of the present invention.

FIG. 11e is a configurable breather slot plate of the present invention.

FIG. 12a shows a right front perspective view of trapezoidal feed screw engagement of the machine of the present invention.

FIG. 12b shows a top view of the trapezoidal feed screw of the machine of the present invention.

FIG. 12c shows a right rear perspective view of the trapezoidal feed screw of the machine of the present invention.

FIG. 12d shows a rear view of the trapezoidal feed screw of the machine of the present invention.

FIG. 12e shows a side view of the trapezoidal feed screw of the machine of the present invention.

FIG. 13a shows the trapezoidal feed screw installation of the machine of the present invention.

FIG. 13b shows a side view of the trapezoidal feed screw installation of the machine of the present invention.

FIG. 14a shows a right front perspective view in position 1 of a 4 hole tube valve of the machine of the present invention.

FIG. 14b shows a right front perspective view in position 2 of a 4 hole tube valve of the machine of the present invention.

FIG. 14c shows a top view of the tube valve of the machine of the present invention.

FIG. 14d shows a rear view of the tube valve of the machine of the present invention.

FIG. 14e shows a right rear perspective view of the tube valve of the machine of the present invention.

FIG. 14f shows a side view of the tube valve of the machine of the present invention.

FIG. 15 shows a mold plate drive train of the machine of the present invention.

FIG. 16a shows a perspective view of the feed screws of the machine of the present invention.

FIG. 16b shows a right front perspective view of the plunger and cylinder assemblies of the machine of the present invention.

FIG. 17 shows the flexible hydraulic power unit of the machine of the present invention.

### DETAILED DESCRIPTION OF INVENTION

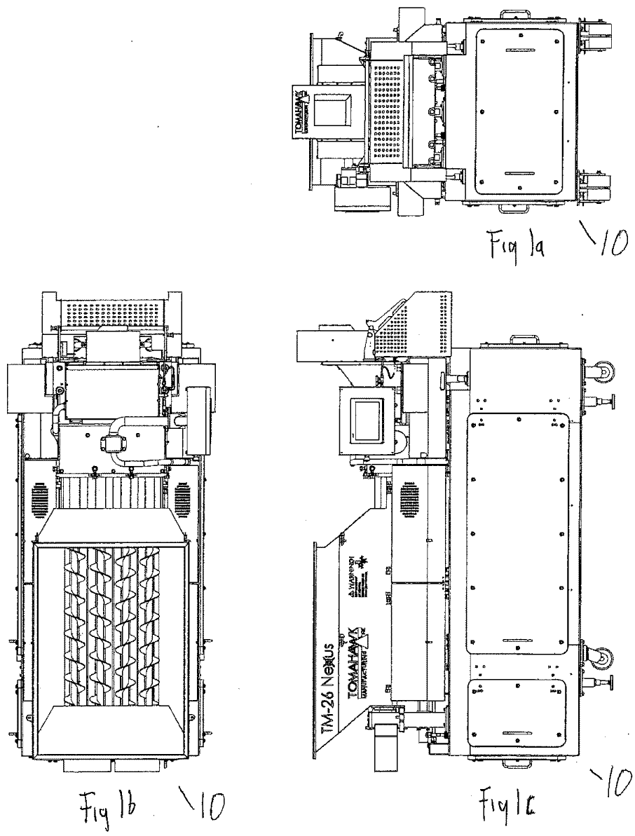

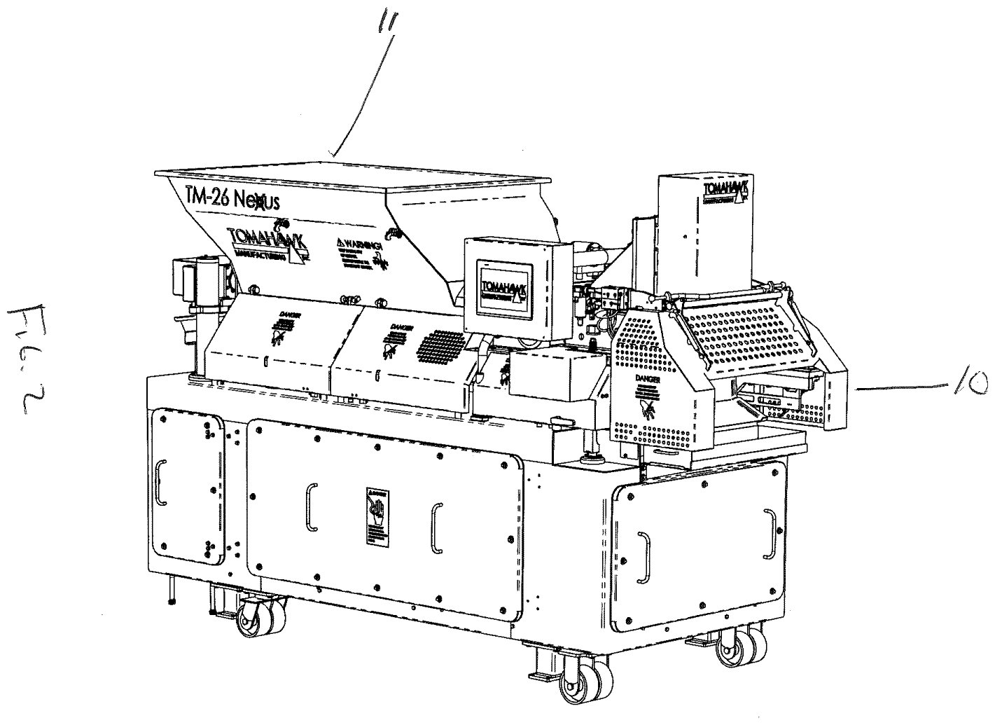

FIG. 1a is a front view of the protein forming machine 10 of the present invention.

FIG. 1b is a top view of the protein forming machine 10 of the present invention.

FIG. 1c is a right side view of the protein forming machine 10 of the present invention.

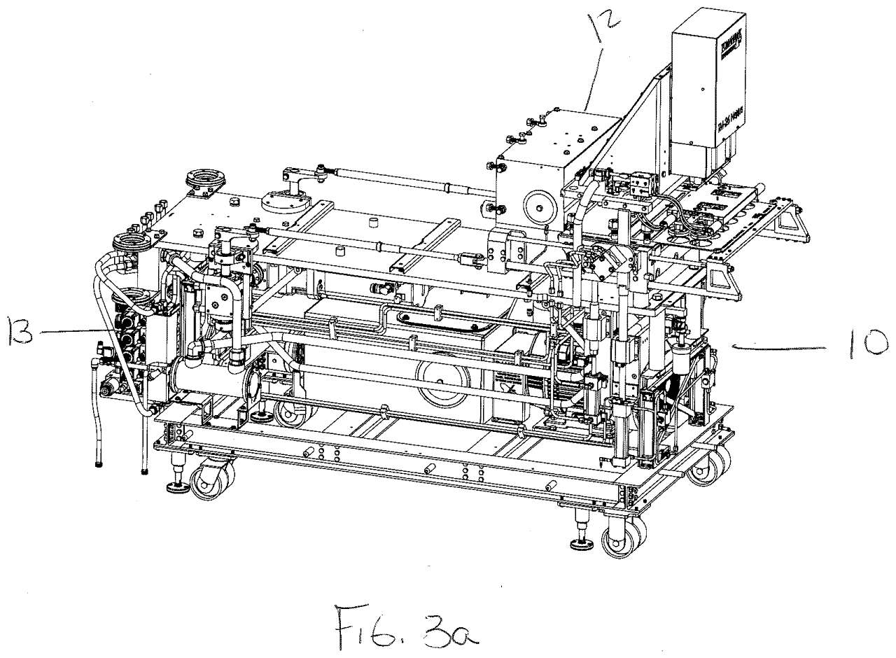

FIG. 2 is a right front perspective view of the protein forming machine 10 having a one piece hopper 11 of the present invention.

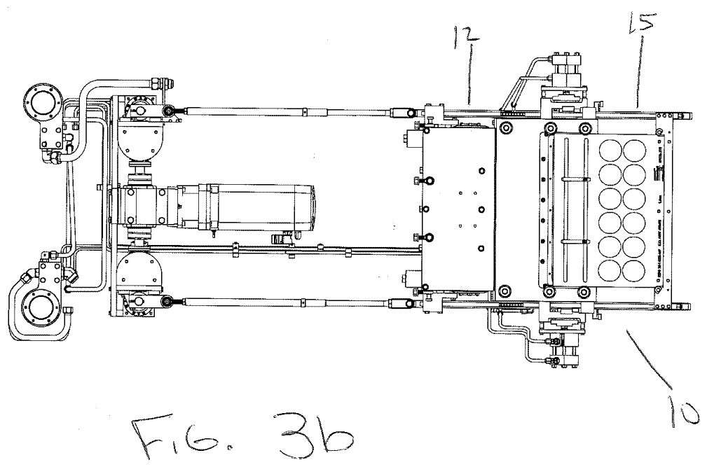

FIG. 3a is a right front perspective view of the protein forming machine 10 having a servo mold plate drive and knockout 12 and hydraulic controls 13 of the present invention.

FIG. 3b is a top view of the protein forming machine 10 having a servo mold plate drive and knockout 12 and a mold plate 15 of present invention.

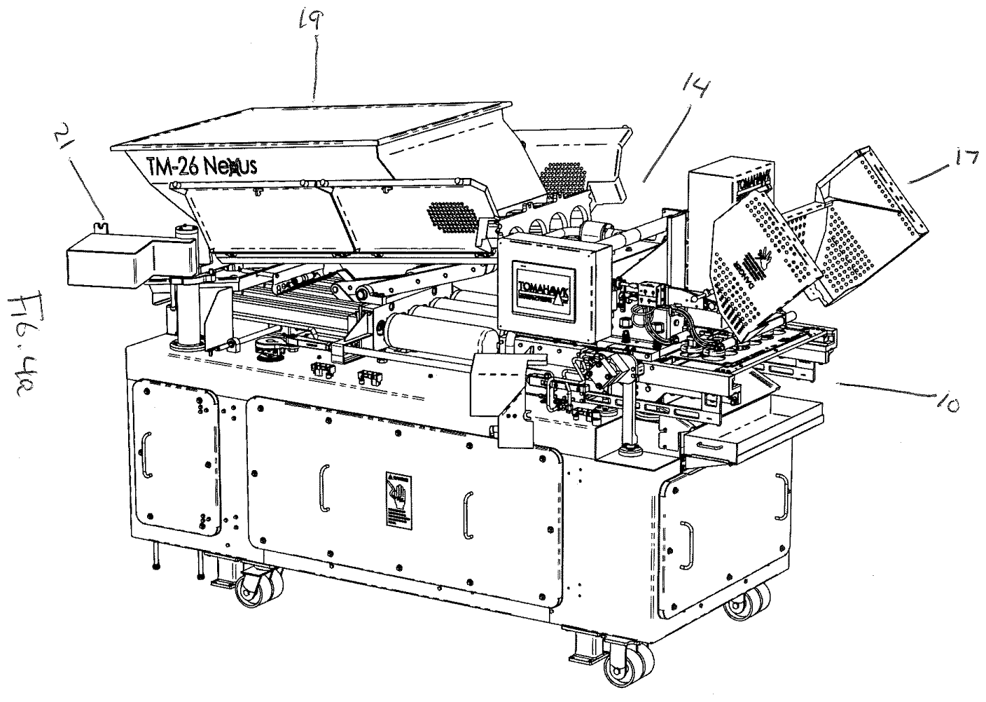

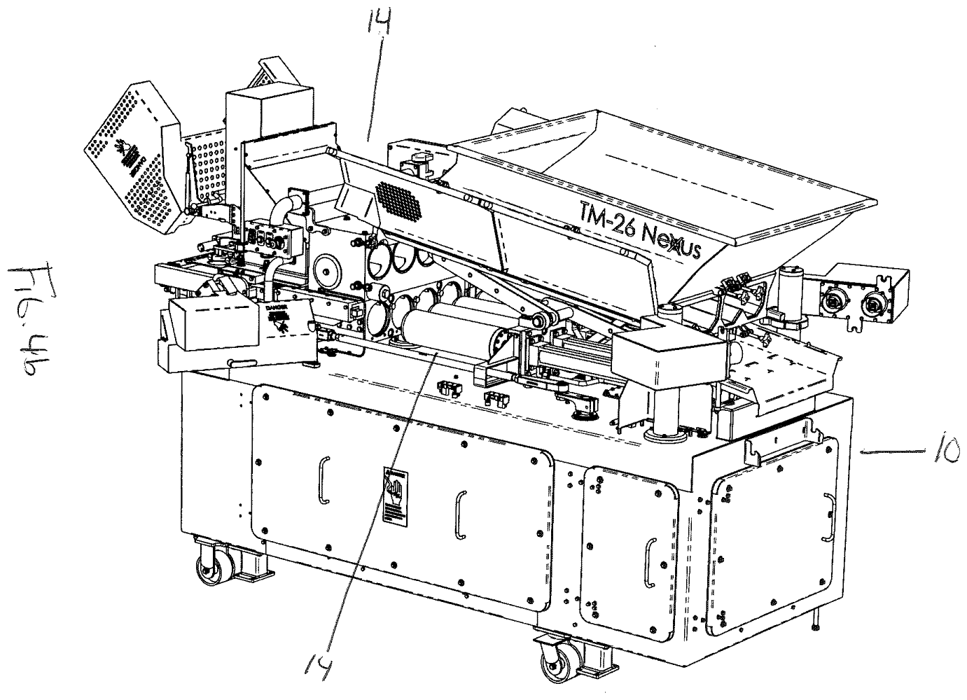

FIG. 4a is a right front perspective view of the protein forming machine 10 wherein the machine 10 can be put in configuration 14 to have rapid clean preparation. In order to provide the rapid clean preparation, guards 17 are opened up, the hopper 19 is tilted, feed screw drives 21 open up, and plungers 23 retract into cleaning position.

This provides easy access for those who clean the machine. The process for getting the machine into cleaning position does not take long.

FIG. 4b is a left rear perspective view of the protein forming machine 10 wherein the machine can be put in configuration 14 to have rapid clean preparation as done with respect to FIG. 4a.

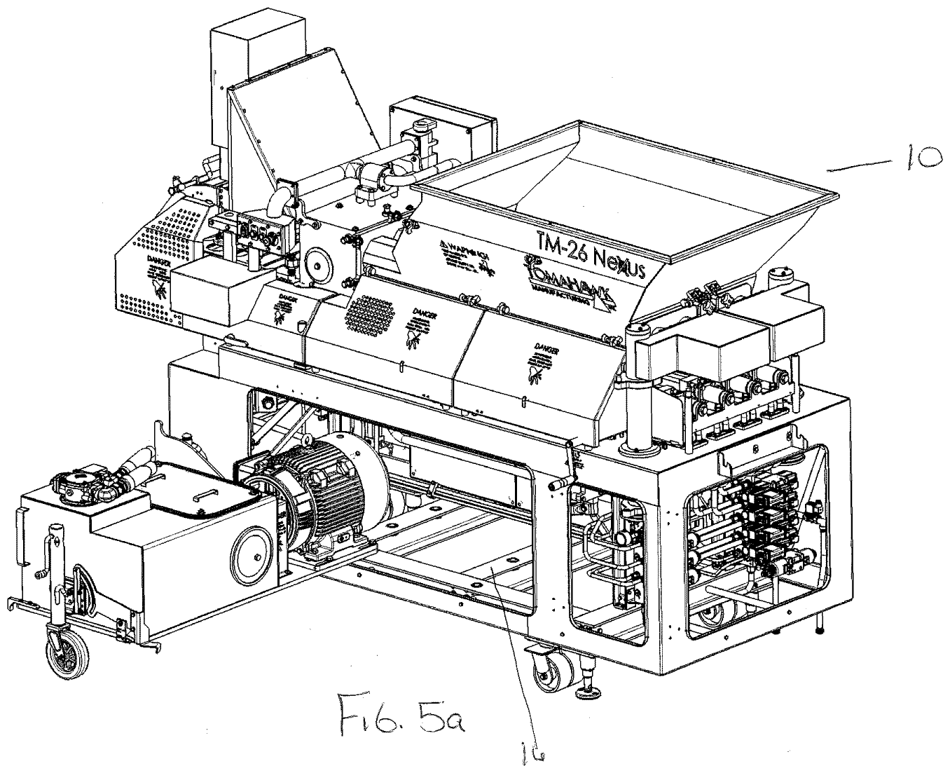

FIG. 5a is a front view of machine 10 showing improved maintenance access 16. The complete hydraulic unit 15 swings out and opens up to inside of machine to access for other systems.

FIG. 5b is a front view of machine 10 shows improved maintenance access 16 having single hydraulic pump 25.

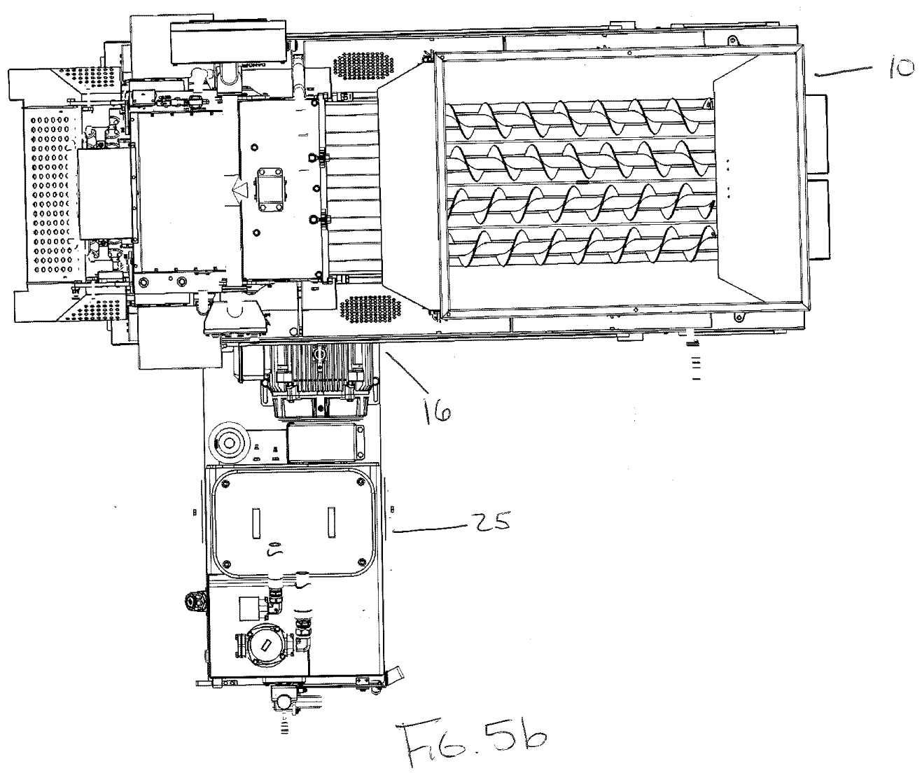

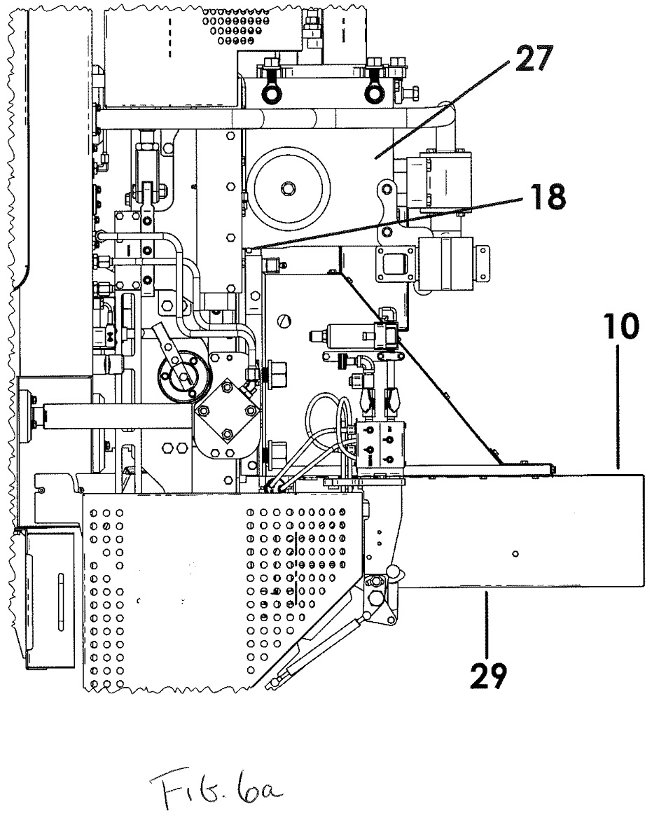

FIG. 6a shows a right side view of a machine 10 having a receiver 27 to mold cover 29, pneumatically activated seal 18.

FIG. 6b shows the enlarged view of FIG. 6a showing machine 10 having a receiver to mold cover pneumatically activated seal 18.

FIG. 6c shows the enlarged view of FIG. 6a showing machine 10 having a receiver to mold cover pneumatically activated seal 18.

FIG. 6d shows the enlarged view of FIG. 6a showing machine 10 having a receiver to mold cover pneumatically activated seal 18.

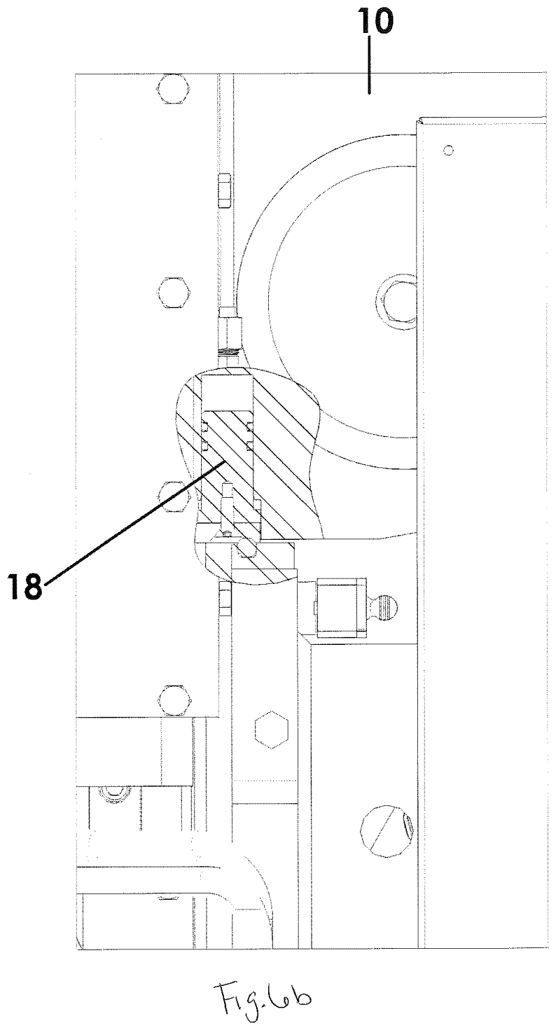

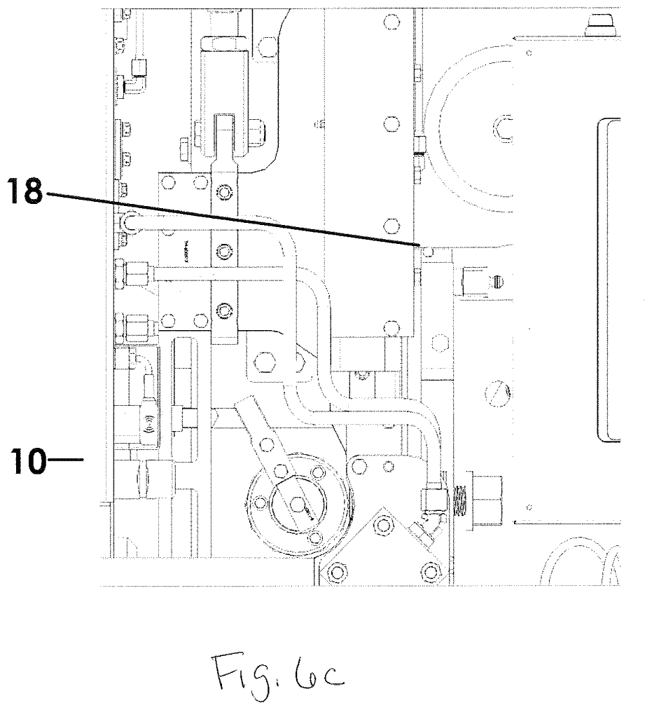

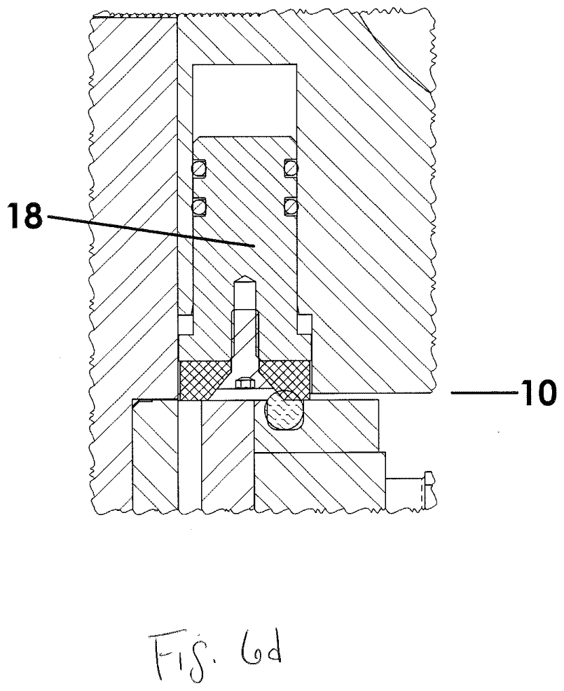

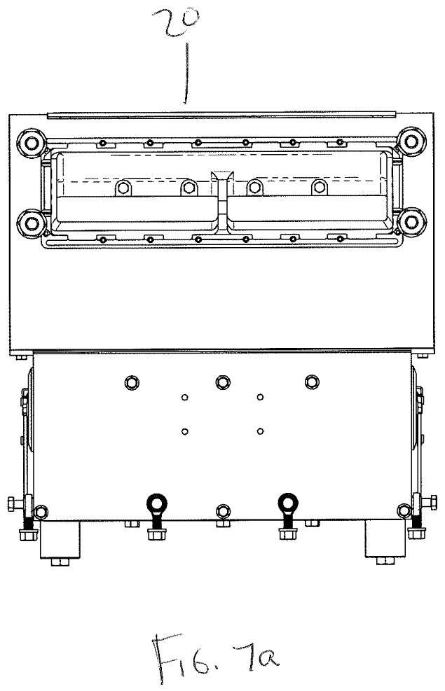

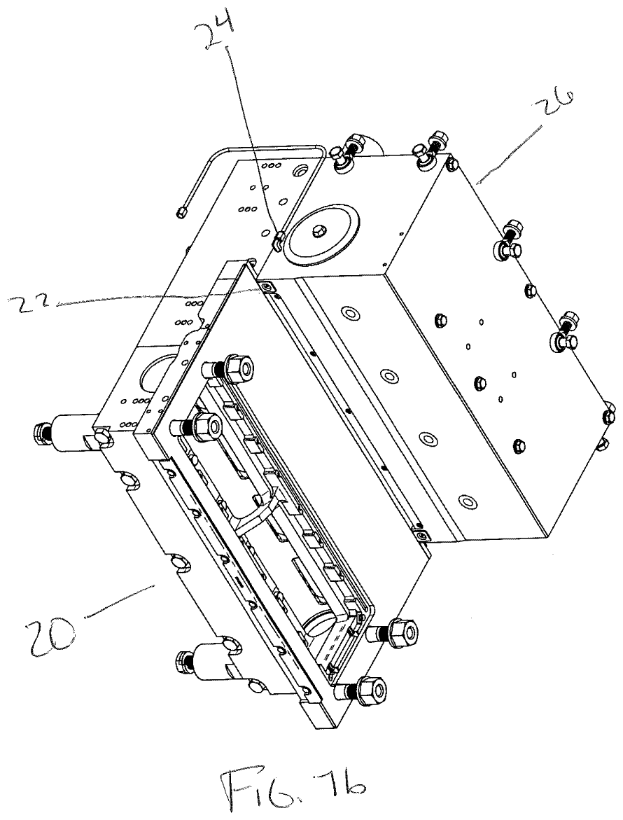

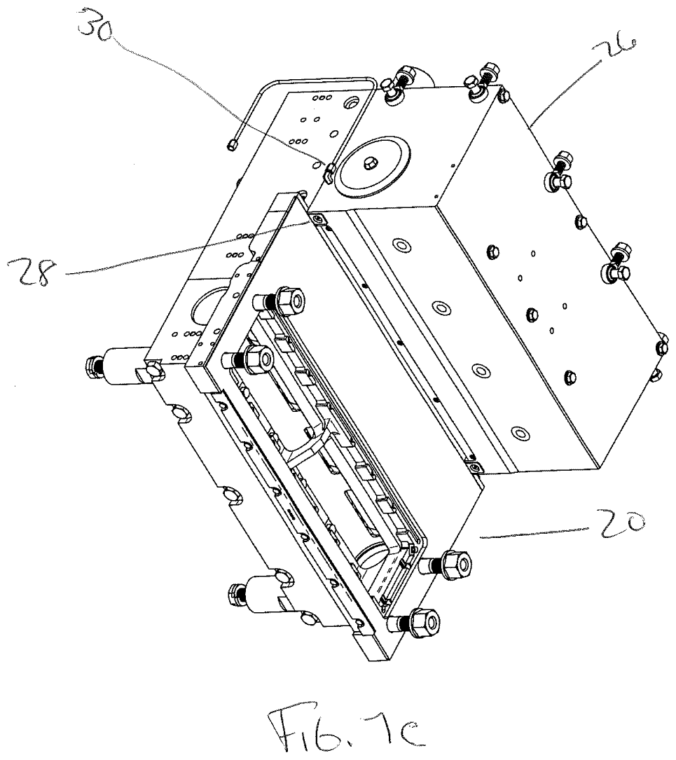

FIG. 7a shows a top view of a receiver and pump box of the machine 20 of the present invention.

FIG. 7b shows a left rear perspective view of the machine 20 having a seal 22 compressed air hole 24 and receiver 26.

FIG. 7c is a right front perspective view of machine 20 having a seal out 28 air in 30 receiver 26.

FIG. 7d is a side view of machine 20 having pneumatically activated seal between mold cover seal and pump box machine of the present invention.

FIG. 7e is a front view of machine 20 having pneumatically activated seal between mold cover seal and pump box of the present invention.

FIG. 7f is a cross-sectional view through section c-c of FIG. 7d.

FIG. 7g is a left rear perspective view of a seal 32 having O-rings 34 and a compressible sealing material face 36.

FIG. 7h shows gap 38 in the pneumatically activated seal between mold cover seal and receiver 20.

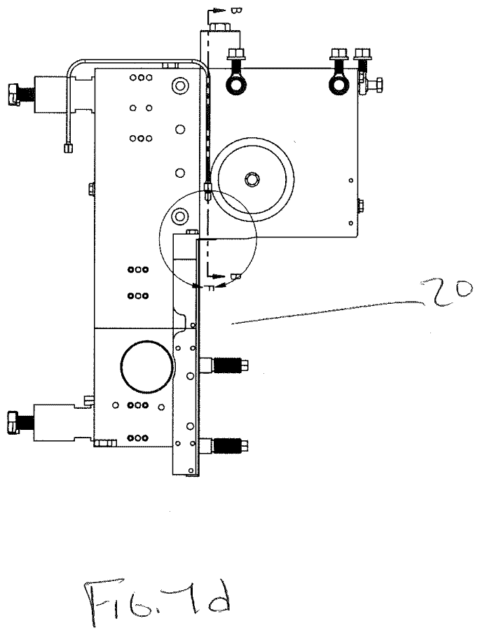

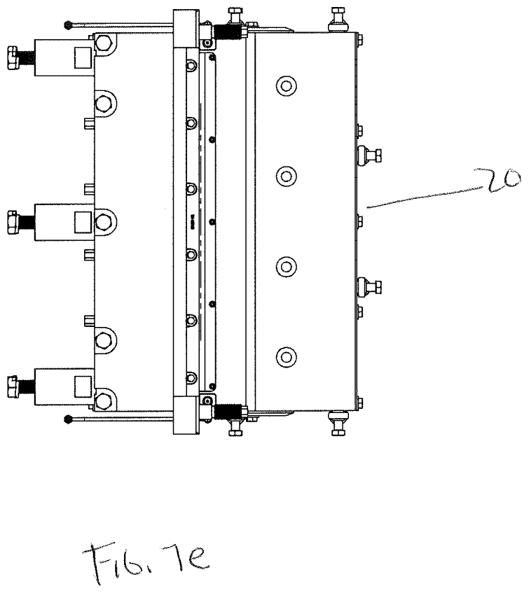

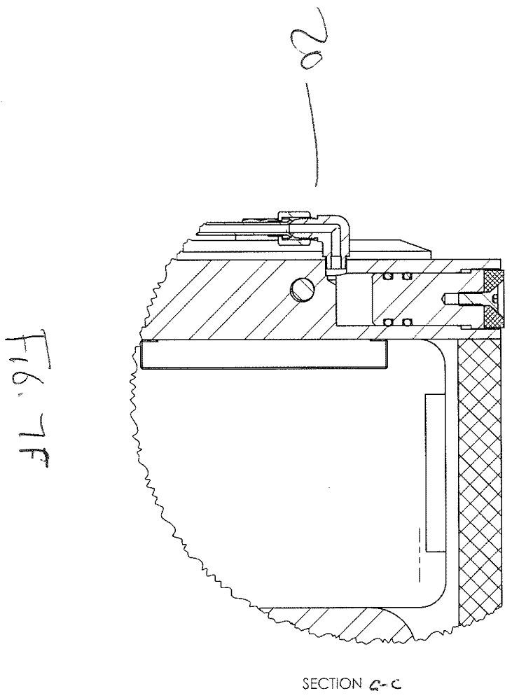

FIG. 8a is a right front perspective view of machine 40 having hopper 42 and a receiver 44.

FIG. 8b is a top view of an assembled O ring seal between a hopper and a receiver of machine 40.

FIG. 8c is an enlarged perspective view of machine 40 having O-rings 46.

FIG. 8d is a side view of machine 40.

FIG. 8e is an enlarged view of O-rings 46 of machine 40.

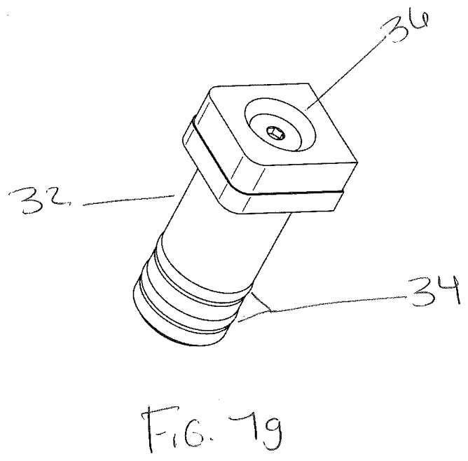

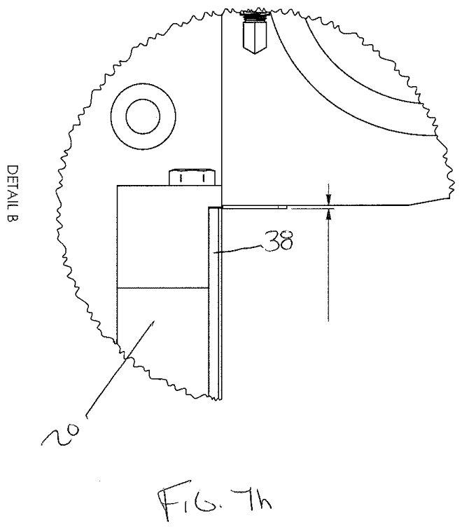

FIG. 9a shows the assembled two-piece pump box assembly 52 with receiver 53 having O-rings 55.

FIG. 9b shows the two piece pre-assembly for the pump box 50.

FIG. 9c shows a side view of the two piece pre-assembly for the pump box 50.

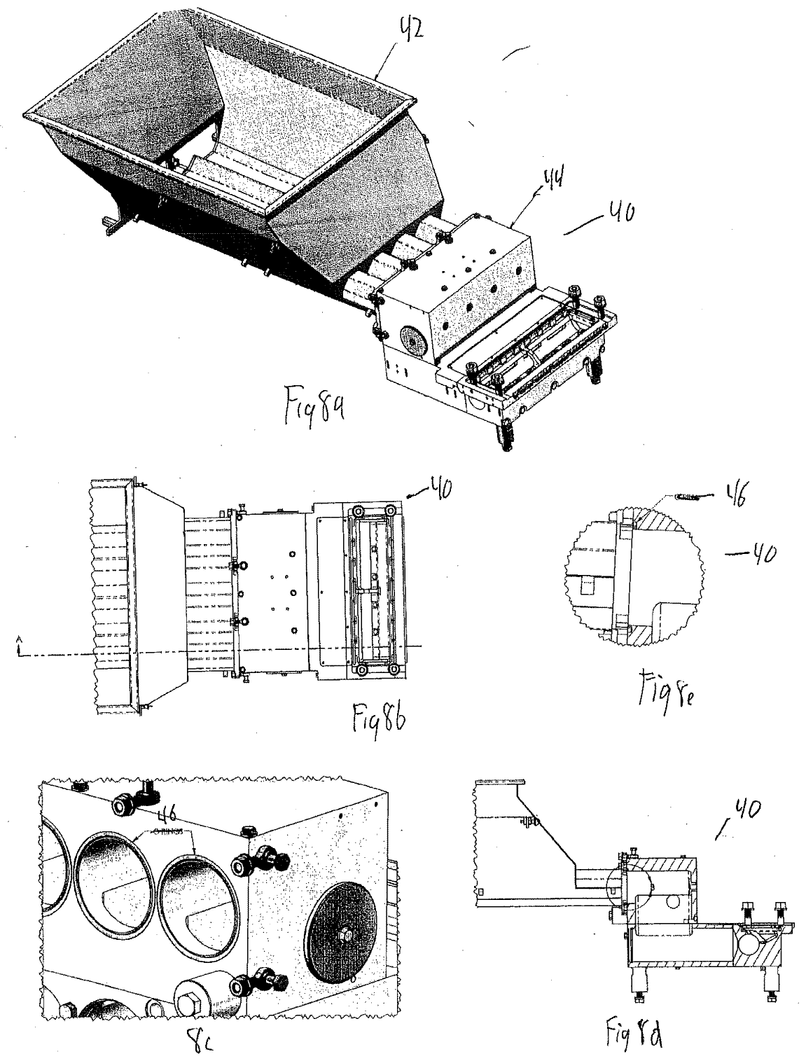

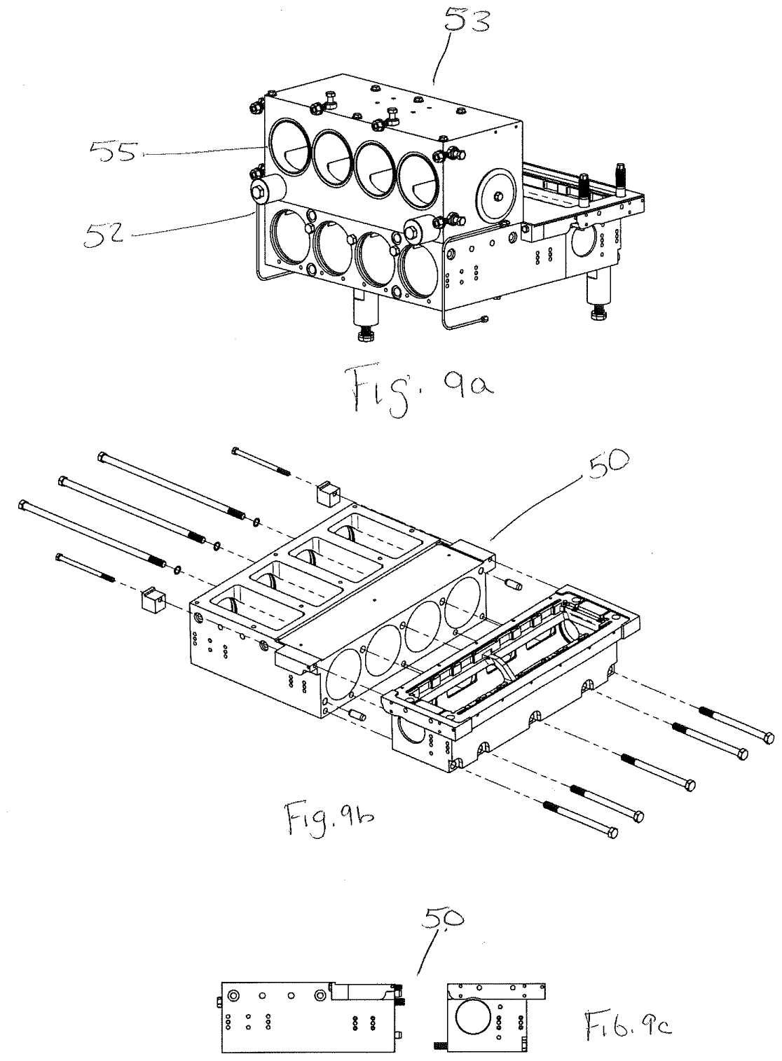

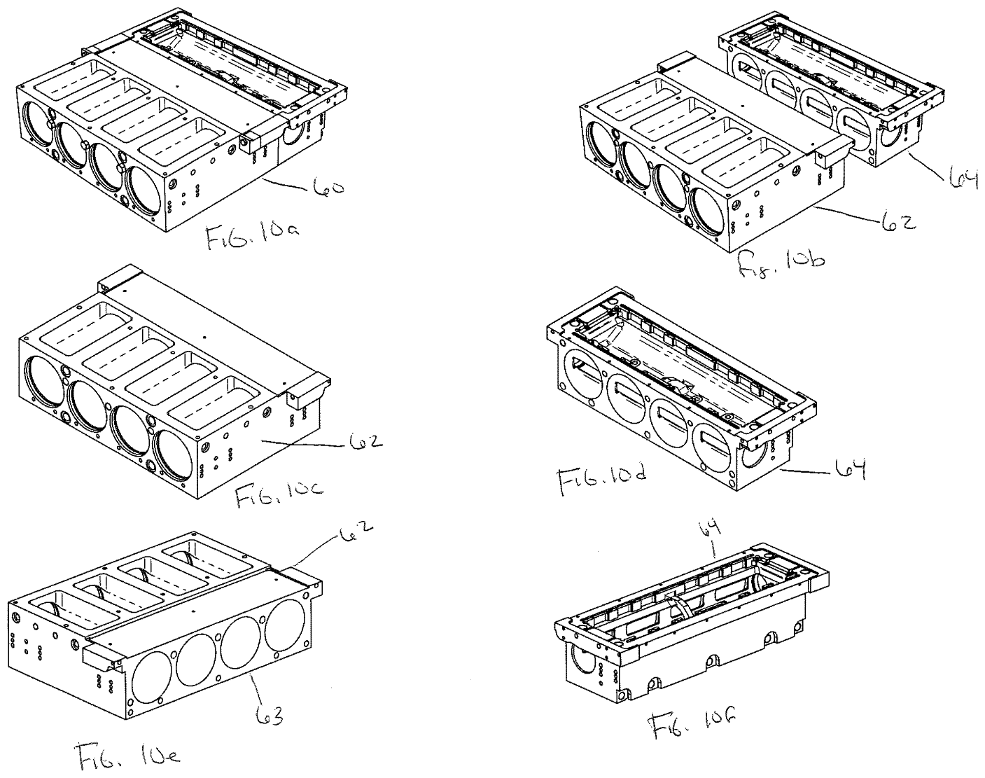

FIG. 10a shows right rear perspective view of the assembled two-piece pump box assembly 60.

FIG. 10b shows right rear perspective view of the two piece pre-assembly pump box 50 having a rear half 62 and a front half 64.

FIG. 10c shows the right rear perspective view of the rear half 62 of the pump box assembly 60 having plunger chamber 63.

FIG. 10d shows the right rear perspective view that shows the front half 64 of the pump box assembly 60.

FIG. 10e shows the right front perspective view of the rear half 62 of the pump box assembly 60 having plunger chamber 63.

FIG. 10f is a right front perspective view that shows the front half 64 of the pump box assembly 60.

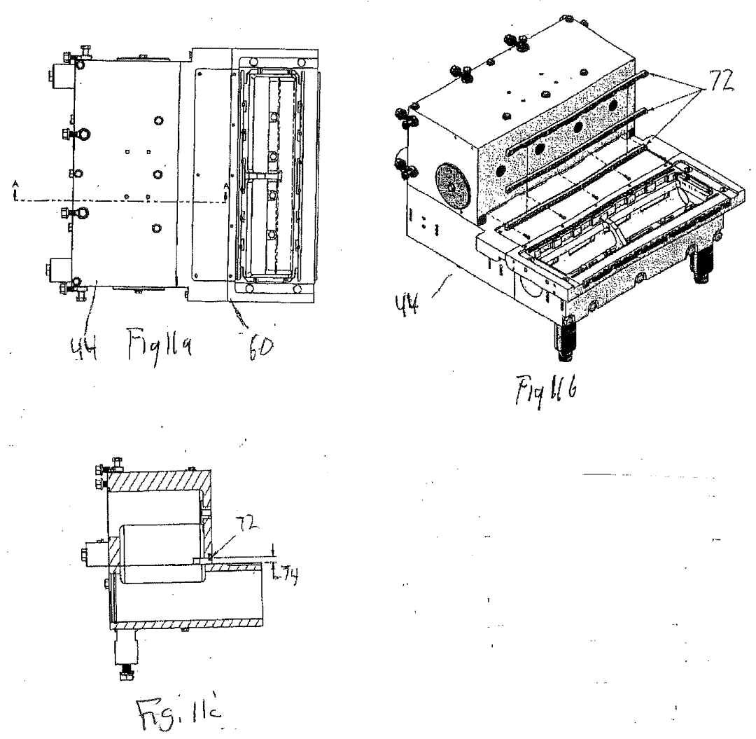

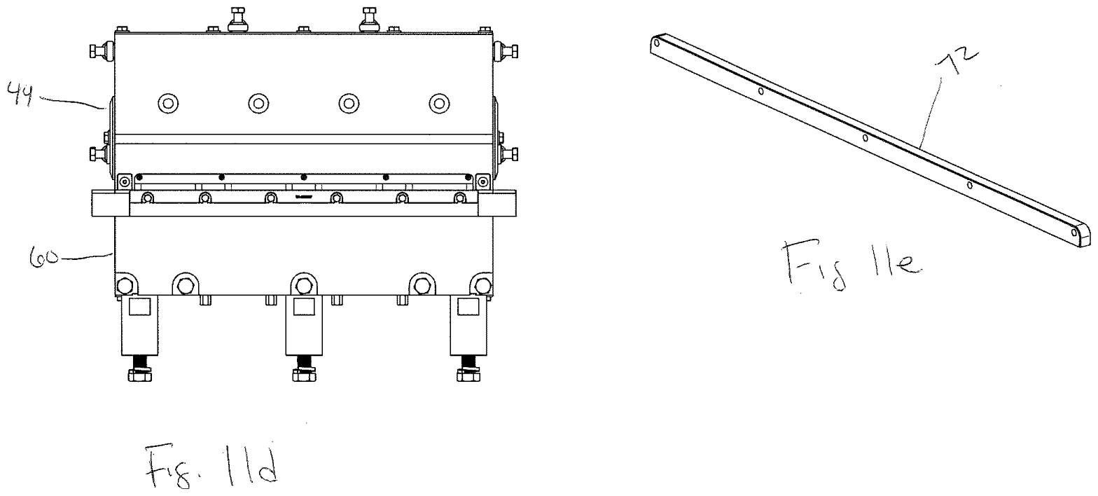

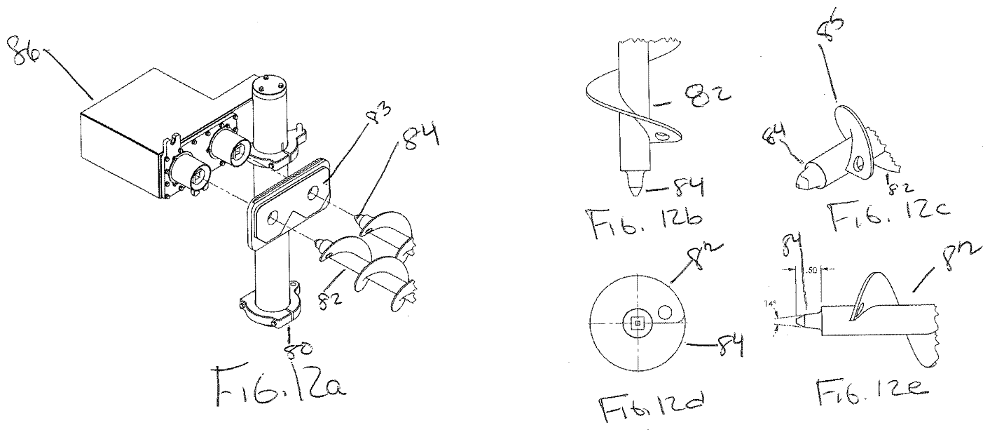

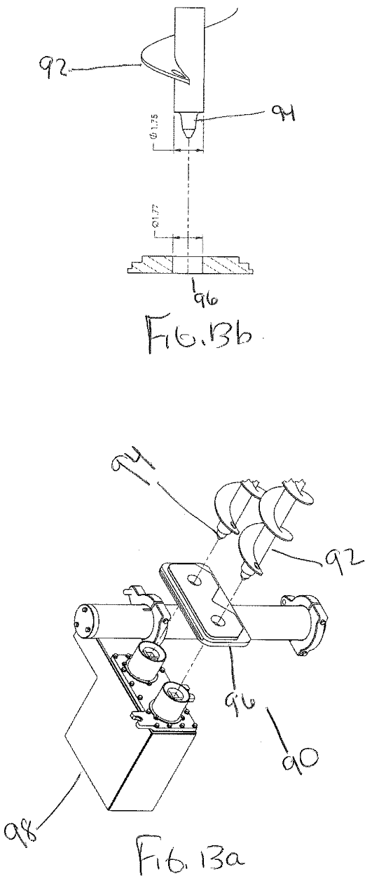

FIG. 11a shows a top view of the pump box 60 and receiver 44.

FIG. 11b shows a right front perspective view of receiver 44 having configurable breather slot plates 72.

FIG. 11c side view of section A-A of receiver 44 having configurable breather slot plate 72 and breather gap 74.

FIG. 11d shows a rear view of pump box 60 and receiver 44.

FIG. 11e shows a configurable breather slot plate 72.

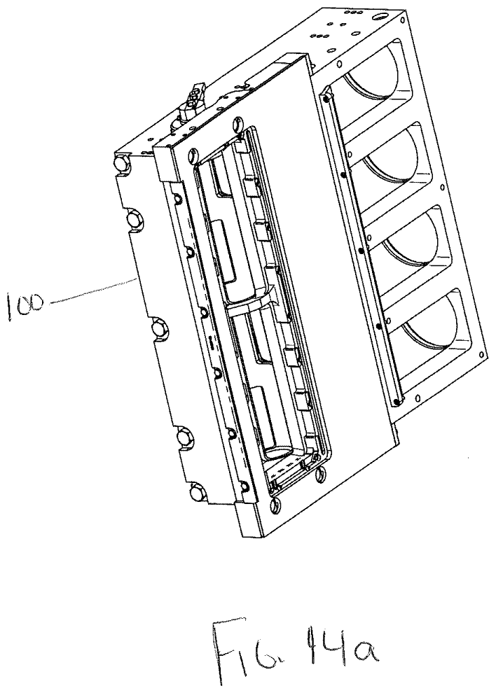

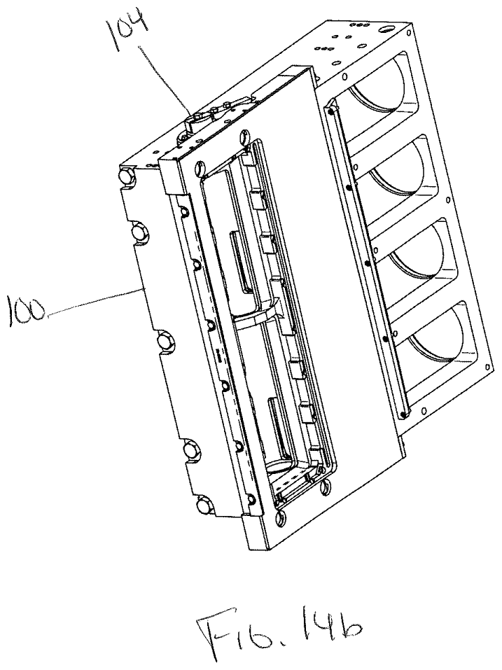

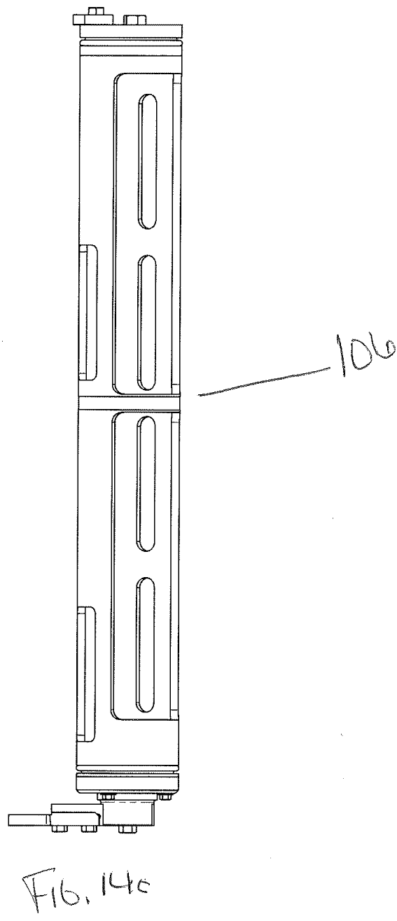

FIG. 12a shows right front perspective view of a trapezoidal feed screw engagement 80 having feed screws 82, a trapezoidal piece 84 and a motor 86, rear hopper seal plate 83. This arrangement allows the feed screw 82 to engage a feed screw drive from any rotation.

FIG. 12b shows a top view of the feed screw 82 having the trapezoidal piece 84.

FIG. 12c shows a right rear perspective view of the feed screw 82 having the trapezoidal piece 84 and flute of spiral screw 85.

FIG. 12d shows a rear view of the feed screw 82 having the trapezoidal piece 84.

FIG. 12e shows the feed screw 82 having the trapezoidal piece 84.

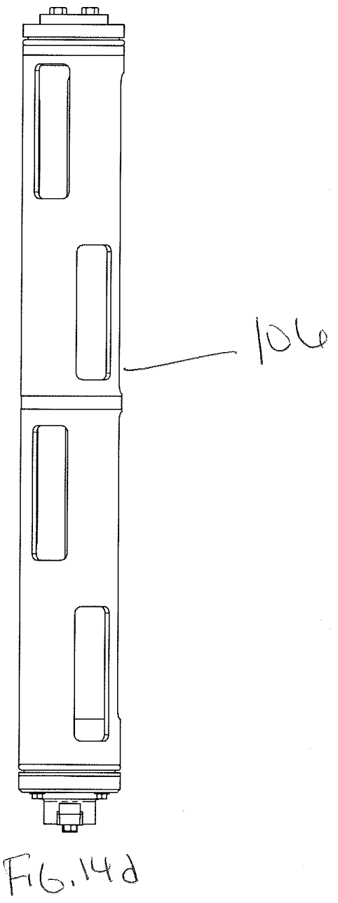

FIG. 13a shows a trapezoidal feed screw arrangement 90 having feeds screws 92, a trapezoidal piece 94, a hopper rear seal 96 and a motor 98.

FIG. 13b shows a feed screw 92, trapezoidal piece 94 and a hopper rear seal 96.

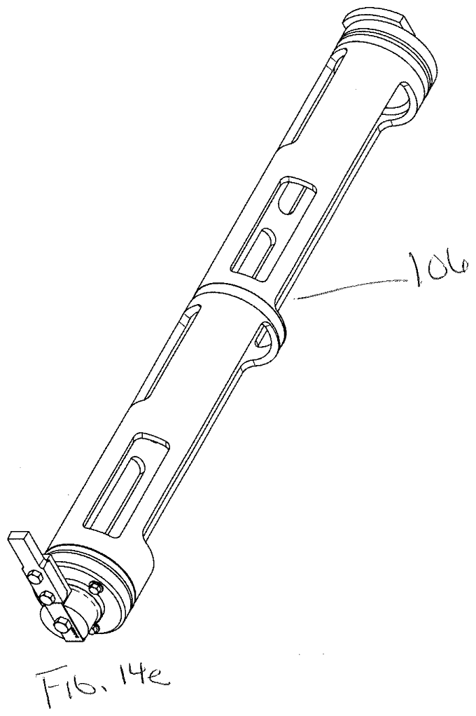

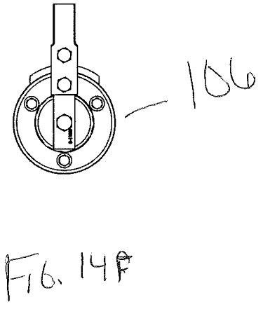

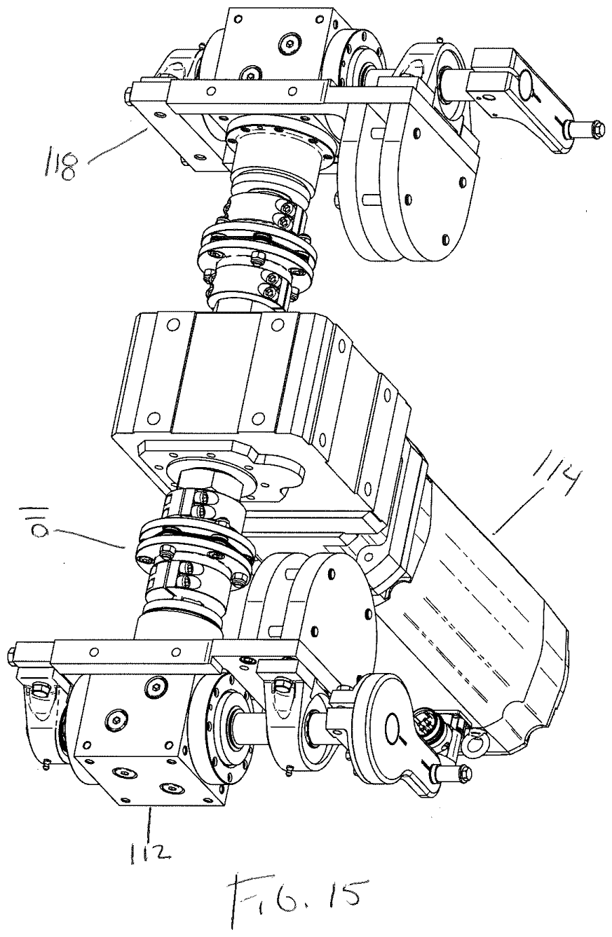

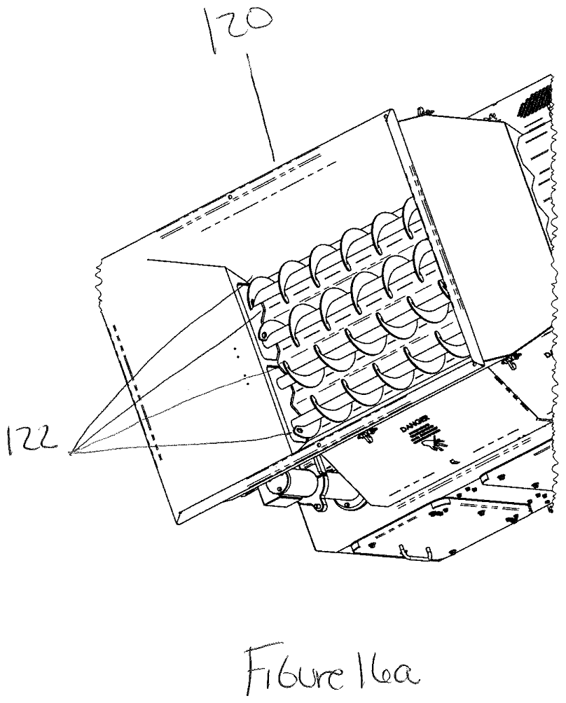

FIG. 14a shows right front perspective view of a four hole tube valve 100 in position 1.

FIG. 14b shows a right front perspective view of a four hole tube valve 100 in position 2 having an arm 104 that rotates up.

FIG. 14c shows a top view of tube valve 106.

FIG. 14d shows a rear view of tube valve 106.

FIG. 14e shows rear right perspective view of a tube valve 106.

FIG. 14f shows a side view of tube valve 106.

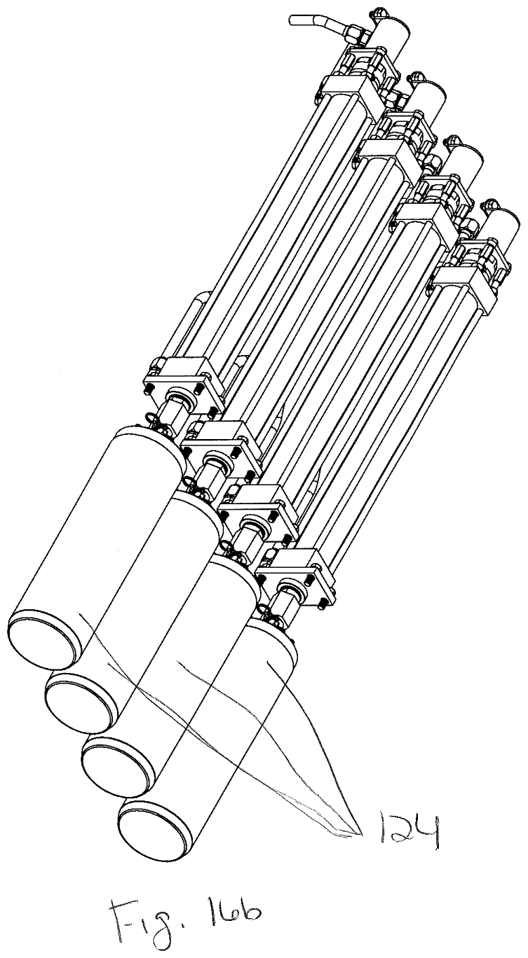

FIG. 15 shows a mold plate drive train 110 having a gearbox 112, servo 114, reducer/splitter 116 and a gearbox 118.

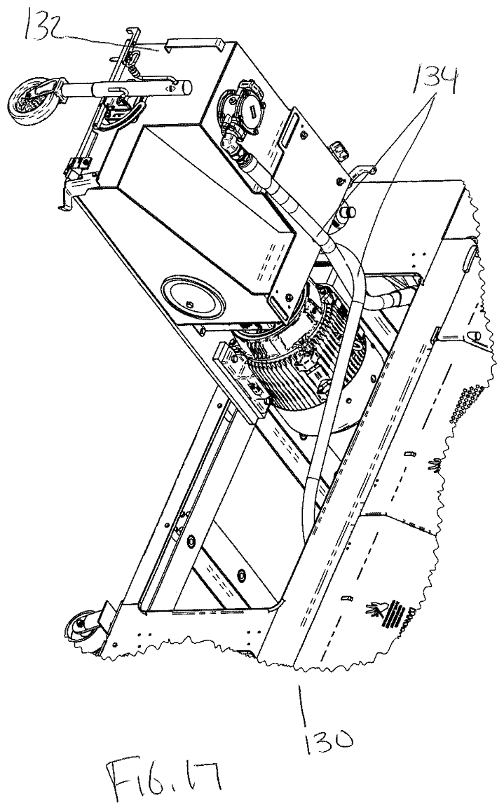

FIG. 16a shows a perspective view of the hopper assembly 120 having feed screws 122, and plunger assemblies 124 shown in FIG. 16b.

FIG. 17 shows the flexible hydraulic power unit 130 comprised of a hydraulic power unit 132 and a flexible hoses 134.

1. A servo-driven plate forming machine comprising:
a mold plate that operates at (120) 10″ strokes per minute;
a single hydraulic pump combined with proportional hydraulic valves with closed and open loop controls;
individually controlled feed screws to control whole muscle integrity and retain particle definition;
a one piece hopper that assists in providing a substantially leak proof feed.

2. The machine of claim 1 further comprising:
providing more control of whole muscle integrity by not using a feed pump to force meat through to a plunger and pump box, but instead said machine traps meat between flutes of spiral screws and sides of a cylindrical chamber, then pushes said meat into a plunger chamber.

3. The machine of claim 2 wherein meat is kept more whole, and experiences less damage to cellular structure.

4. The machine of claim 2 wherein said machine uses hydraulic controls to control pressure of meat in said pump box and mold plate and uses closed loop feedback of pressure.

5. The machine of claim 4 wherein said hydraulic controls provide desired amount of pressure placed on said meat in a mold cavity.

6. The machine of claim 5 wherein said machine provides improved portion weight control system provides more consistent filling of cavities.

7. The machine of claim 5 wherein said hydraulics are quickly reactive with less lag time.

8. The machine of claim 1 wherein said machine comprises a servo driven mold plate and knock-out.

9. The machine of claim 1 further comprising proportional plunger hydraulics.

10. The machine of claim 1 further comprising pneumatically activated seal to stop leaks between mold cover, receiver and pump box.

11. The machine of claim 1 further comprising an O-ring located between hopper and receiver that assists in minimizing leakage in this area.

12. The machine of claim 1 further comprising a configurable breather slot using configurable inserts, said breather slot is removable to change how big said breather the slot is;
said configurable breather slot controls breathing in fill system, assists in proper filling of mold plate cavities and reduction in product loss.

13. The machine of claim 1 further comprising a feed screw installation as part of drive where rear hopper seal plate allows movement so feed screws self-align when operator closes feed screw gear motors to engage feed screws.

14. The machine of claim 1 further comprising a trapezoidal or pyramid feed screw drive engagement.

15. The machine of claim 1 further comprising a trapezoidal feed screw engagement comprising feed screws, a trapezoidal piece and a motor.

16. The machine of claim 1 further comprising flexible hydraulic power unit connections that allow said hydraulic power unit to rotate out of said machine for services/adjustments without disconnecting hoses.

17. The machine of claim 1 wherein said machine has a two-piece pump box.

18. The machine of claim 1 further comprising four programmable feed screws and four round plungers to minimize leakage and give uniform mold cavity filling.

19. The machine of claim 1 wherein said machine is designed to produce formed poultry, beef, sausage and plant based protein.

20. The machine of claim 1 further comprising a mold plate drive train having a single main reducer, driven by a single servo motor;
said main reducer having two output shafts which split power into two 1:1 direction changing gearboxes.

21. The machine of claim 1 further comprising a mold plate drive train having a gearbox, servo, reducer/splitter and a gearbox.

22. The machine of claim 1 further comprising a rotary tube valve having four holes fed by four plungers.

23. The machine of claim 1 wherein said machine precisely commands position and pressure of plungers via a closed loop feedback for position and pressure independently along with open loop feedback for flow rate independent of position and pressure.

24. The machine of claim 1 wherein said machine comprises a configuration to have rapid clean preparation wherein guards are opened up, said hopper is tilted, feed screw drives open up, and plungers retract into cleaning position.
